(19) United States
(12) Patent Application Publication
(10) Pub. No.: US 2017/0228841 A1
(43) Pub. Date: Aug. 10, 2017

(54) METHOD AND SYSTEM OF A REAL ESTATE BROKER REFERRAL NETWORK PLATFORM

(71) Applicant: David J. Howie, Lincoln, CA (US)

(72) Inventor: David J. Howie, Lincoln, CA (US)

(21) Appl. No.: 15/423,612

(22) Filed: Feb. 3, 2017

Related U.S. Application Data
(60) Provisional application No. 62/293,277, filed on Feb. 9, 2016.

(51) Int. Cl. G06Q 50/16; G06Q 20/08

(52) U.S. Cl. CPC G06Q 50/167; G06Q 20/085

(57) ABSTRACT

Disclosed are a method and/or a system of a real estate broker referral network platform. The method provides an interface to a referring broker licensed in a first jurisdiction to select a recipient broker chosen among a set of brokers in a second jurisdiction. The method automatically populates a set of information in a referral contract between the referring broker and the recipient broker based on a set of criteria provided by the referring broker and the recipient broker using a processor and a memory. The method determines that a referred client has entered into an escrow associated with at least one of a sale, a purchase, and/or a lease of a real property with the recipient broker with an escrow provider. The method automatically communicates the referral contract to the escrow provider which credits a consideration to the referring broker upon a close of the escrow.

### CLAIM OF PRIORITY

This non-provisional patent application is a conversion application of and claims priority to the U.S. Provisional Patent application No. 62/293,277 titled METHOD AND SYSTEM OF A REAL ESTATE BROKER REFERRAL NETWORK PLATFORM filed on Feb. 9, 2016.

### FIELD OF TECHNOLOGY

This disclosure relates generally to real estate agreements, and more particularly, to a method and/or a system of a real estate broker referral network platform.

### BACKGROUND

In a real estate marketing environment, searching for real estate agents and/or brokers for the purpose of sending and/or receiving client referrals involves expending large amounts of time and money. The real estate brokers and/or agents that are active in one market space may often experience difficulty finding referral real estate brokers and/or agents for a client wishing to sell and/or buy a property in a different market space. This may require an active real estate broker and/or agent of one market space to contact an active real estate broker and/or agent in another market space in which the client wishes to buy and/or sell the property. The referring broker and/or agent may not have enough information about the real estate brokers who are active in the different market space. The referring broker may not have a previous record of the recipient broker to use in authenticating the recipient broker's status. Further, the referring broker may desire the opportunity to obtain a referral fee from the recipient broker in exchange for its referral. The referring broker may be unable to search for a well suited broker willing to pay the maximum referral fee for the referral.

The referring broker may only receive a certain amount of commission derived from a sale and/or purchasing price after the sale and/or purchase has actually been made. The referring broker may not have any control and/or any means to track further processes once the referral has been made. In addition, the referring broker may fail to ensure that the referred client is being served well by the recipient broker. Lack of real-time information about the ongoing processes may be detrimental for customer satisfaction relating to the referring broker. Conventional methods do not offer an efficient and standardized process for allowing the referring broker to engage in customized negotiations and/or retain an element of control over the referral fee and/or the referred client's customer satisfaction.

### SUMMARY

The present invention is a method and/or a system of a real estate broker referral network platform, according to one embodiment.

In one aspect, a method and/or a system of this invention enables creating a search and discovery platform for real estate agents and/or brokers to search and discover each other for the purpose of sending and/or receiving client referrals in exchange for referral fees. While it is common practice to send and receive client referrals to other agents for multiple reasons, this invention allows any licensed real estate agent and/or a broker to easily send and/or receive a client referral(s). The referring real estate agent and/or broker may securely send and/or receive the corresponding referral fee from the recipient real estate agent and/or broker in any other real estate market in the world by using a computing device.

According to another aspect, the method and/or system will provide for generating a referral fee agreement on the real estate broker referral network platform and/or customizing the referral fee agreement based on particular features of the relationship between the referring real estate agent and/or broker and the referred real estate agent and/or broker. Further, the method and/or system will track the customized referral fee agreement on the platform until such time that all parties to the agreement have either performed their obligations under the terms of the agreement and/or the agreement is cancelled and/or nullified.

According to yet another aspect of this invention, the real estate broker referral network platform may be configured to verify and obtain any licensing certifications for the referred real estate agent and/or broker that may be required by the laws of each local jurisdiction in which the transaction is to take place.

This invention allows for users and/or real estate brokers to contractually engage with one another on the online referral network platform. The real estate broker referral network platform enables the referring broker and/or agent and the referred broker and/or agent to enter into a legally binding contract in the form of a referral fee agreement with each other in real estate markets that are located in different areas. The real estate broker referral network platform allows for handling multiple contracting parties and/or resulting interactions and/or transactions on a large scale. This invention includes a tracking mechanism to monitor an exponential growth of contractual combinations integrated within the real estate broker referral network platform.

In a further aspect, the referral fee agreement generated using the real estate broker referral network platform will include two main parties to the agreement, the referring broker and the recipient broker. The client being referred by the referring broker may also be identified in the referral fee agreement as a principal. In addition, the referral fee agreement may also identify the referral fee and/or the duration of the agreement. Specifics of what services the recipient broker provides for the principal may also be identified in the referral fee agreement. The referral fee agreement may further include services to be provided by the recipient broker such as selling and/or leasing a specific property in a specific time period, and/or buying a property within a specific time period.

In yet another aspect, a crucial element of the referral fee agreement may be the consideration given for the referral. The invention will enable the referring real estate agent and/or broker to negotiate with the recipient real estate agent and/or broker the amount of consideration to be paid for the referral. The referral fee may be expressed as a percentage of the gross commission received by the recipient broker for services rendered to the referred client. For example, the referral fee may be 25% of the gross commission received. In other situations, the referral fee may be as high as 100%, for example, when a home builder has their own sales staff and will be making their profit from the sale of the new home. In other situations, the referral fee may be a fixed amount. This invention enables the recipient broker to customize how they would like to pay the consideration and/or enables the referring broker to customize how they would like to receive the consideration. For example, the recipient broker may ultimately be compensated in a foreign currency or digital currency and may wish to pay the consideration owed in the same form of currency. This invention will keep a distributed ledger system of all referral fees paid through the platform and automatically exchange the currency into the desired form of currency payment that the referring broker has chosen to receive through the platform. This invention creates a global marketplace for referrals between real estate agents and/or brokers across different markets and allows real estate agents and/or brokers to dynamically list their prices for referrals in real time based on a number of considerations (e.g., their work flow, current influx of business, and/or current demand for services). For example, a broker in San Francisco may have a client needing to purchase a condominium in New York City. The San Francisco broker can utilize this invention to search and discover a qualified, authenticated, licensed, New York City Broker willing and able to accept client referrals. A real estate broker referral network platform search query could list multiple agents for the referral and the referring San Francisco broker could filter and sort the search results to find a well suited broker willing to pay the highest referral fee for the referral, thus providing maximum value to the referring broker.

This search and discovery process may further enable the referring broker to select a recipient broker based upon asymmetrical information that the referring broker will have about the referred client (e.g., the client's needs and/or desired location, price range, and/or type of property). The real estate broker referral network platform will enable this client information to be efficiently conveyed to the recipient broker. This enables the referring broker to bypass other third party systems and select the desired recipient broker themselves using the real estate broker referral network platform. Due to the nature of the real estate business, it is important to evaluate and/or assess the potential relationship that may be created by the transaction before entering into a formal arrangement. This invention makes it more efficient to consider this human interaction element by using the selection process that enables the referring broker to systematically route real estate client referrals to the most appropriate recipient real estate agent and/or broker.

Once a willing and able recipient broker is identified, the referral fee agreement can be drafted on the real estate broker referral network platform using a computing device. The referring agent would be able to input the client(s) information and/or other requirements (e.g., directly from his or her contacts) using a computing device (e.g., a computer, a tablet, and/or a smart phone.). The referral fee agreement will then get auto-populated on the computing device of the relevant user(s) (e.g., the referring real estate agent and/or broker and/or the recipient real estate agent and/or broker). The resulting referral fee agreement can then be fully executed by all parties digitally and securely in a matter of minutes, saving both time and money. Each referral fee agreement will be assigned a unique ID by the real estate broker referral network platform which is used to track that particular referral fee agreement within the system. With a fully executed referral fee agreement in place, the referring broker can then facilitate an introduction to the recipient broker to provide the referred client with the recipient broker's services.

After the introduction has been made and the referred client is working with the recipient broker, the recipient broker may provide updates on the transaction using the real estate broker referral network platform (e.g., itemize the properties shown, offers submitted, and/or offers received after a listing is on the market). This additional information may automatically trigger the real estate broker referral network platform to send signals and/or notifications to the referring broker through the real estate broker referral network platform. This will enable the referring broker to better assess how the referred client is being served and/or anticipate the referred client's level of customer satisfaction and/or take any necessary steps to ensure that the referred client will be satisfied. Once there is a contract to purchase and/or sell real estate property relating to the terms of the referral agreement, the recipient broker will provide this update relating to the transaction using the real estate broker referral network platform. For example, the recipient broker may provide the escrow number and/or escrow officer contact information. The real estate broker referral network platform may then use this information regarding the transaction to generate an automated broker demand to escrow which will have specific instructions enabling the real estate broker referral network platform to track the referral fee payment process. The broker demand will instruct escrow to wire a specific amount of funds from escrow to a platform controlled broker trust account. The funds wired from escrow, per the broker demand and instructions, will be associated with the referral fee agreement unique ID.

Once the wire has been received into the broker trust account, in the amount expected along with the unique referral fee agreement identifier, the system will be able to automatically disburse the funds as agreed upon in the referral fee agreement and platform user agreement in the manner specified by the referring broker (e.g., the referring broker may choose to receive funds by check, wire, and/or ACH transfer). This automated payment process can increase the escrow payment cycle speed from a few business days from the close of escrow to a few banking hours from the close of escrow.

In one more aspect, this invention allows for direct feedback to be given to the referring brokers and/or agents for their client referrals. The online referral network platform also has the flexibility for the brokers to direct the referral fee payments to their referring agents directly so that the brokers can receive passive income that does not need to be processed internally and then paid out to the agent per their compensation plan. This feature, if desired by the brokers, will then fully automate the payment process from start to finish. The referring broker will be in full control of their referral fee payments and can customize how they wish to receive the payment.

The real estate broker referral network platform will act as a market place for real estate referrals and also a clearing house for the referral payment process by tracking all funds transferred through the real estate broker referral network platform. The real estate broker referral network platform thus automates the payment process. This process would comply with all IRS and/or local regulatory licensing agency requirements. Further, the real estate broker referral network platform enables a more streamlined and efficient process while additionally providing for better monitoring of an entire transaction from start to finish.

In yet another aspect, the real estate broker referral network platform may authenticate its users (e.g., recipient brokers) through their Multiple Listing Service (MLS) credentials and/or the National Association of Realtors database. The real estate broker referral network platform may also enable real estate brokers and/or agents to communicate with each other, form groups, message, and/or blog. Each realtor that subscribes to the MLSs will have a unique MLS Identifier, which can be searched. This unique MLS Identifier enables the referring broker to see how many properties a particular broker has sold from the last 12 months or up to 5 years. This unique MLS Identifier can be used by the real estate broker referral network platform as a tool to authenticate a broker. The real estate broker referral network platform may also have a broker's profile listing how many properties that particular broker has sold, how many buyers they have represented, what types of properties they have sold, and/or personalized reviews from their customers.

This invention enables a free flow exchange of referrals, forming contractual agreements, monitoring the whole process, reviewing current and/or prior transactions, and/or giving reviews relating to a particular transaction and/or real estate agent and/or broker.

### BRIEF DESCRIPTION OF THE DRAWINGS

The embodiments of this invention are illustrated by way of example and not limitation in the figures of the accompanying drawing, in which like references indicate similar elements and in which:

FIG. 1 is a network view illustrating the search and verification of a recipient broker by a referring broker using a real estate broker referral network platform based on referring broker search criteria of a real estate broker referral server, according to one embodiment.

FIG. 2 is a network view illustrating the generation of a referral fee agreement between the referring broker and the recipient broker in the real estate broker referral network platform based on a referral agreement search criteria of the referring broker of the real estate broker referral server of FIG. 1, according to one embodiment.

FIG. 3 is a user interface view illustrating the recipient broker updating the agreement status in the real estate broker referral network platform of the real estate broker referral server of FIG. 1, according to one embodiment.

FIG. 4 is a user interface view illustrating the reviewing of the Multiple Listing Services status of a registered broker based on unique broker ID in the real estate broker referral network platform of the real estate broker referral server of FIG. 1, according to one embodiment.

FIG. 5 is a graphical process flow view illustrating the transaction verification process of the real estate broker referral server of FIG. 1, according to one embodiment.

FIG. 6 is a process flow detailing the operations involved in generation of a referral fee agreement between a referring broker and a recipient broker in a real estate broker referral network platform and verification of transfer of referral fee by the real estate broker referral server of FIG. 1, according to one embodiment.

FIG. 7 is a schematic diagram of exemplary data processing devices that can be used to implement the methods and systems disclosed herein, according to one embodiment.

Other features of the present embodiments will be apparent from the accompanying drawings and from the detailed description that follows.

### DETAILED DESCRIPTION

Disclosed are a method and/or a system of a real estate broker referral network platform 110, according to one embodiment.

In one embodiment, a method and/or a system of this invention enables creating a search and discovery platform (e.g., real estate broker referral network platform 110) for real estate agents and/or brokers (e.g., referring broker 106, broker 124A-N, recipient broker 132) to search and discover each other for the purpose of sending and/or receiving client referrals in exchange for referral fees (e.g., using referral fee agreement 206 of the real estate broker referral server 100). While it is common practice to send and/or receive client referrals to other agents for multiple reasons, this invention allows any licensed real estate agent and/or a broker (e.g., referring broker 106, broker 124A-N, recipient broker 132) to easily send and/or receive a client referral(s). The referring real estate agent and/or broker (e.g., referring broker 106, broker 124A-N) may securely send and/or receive the corresponding referral fee (e.g., using referral fee agreement 206 of the real estate broker referral server 100) from the recipient real estate agent and/or broker (e.g., recipient broker 132) in any other real estate market (e.g., second real estate market space 122 of the real estate broker referral server 100) in the world by using a computing device (e.g., referral computing device 114A, 114B).

According to one embodiment, the method and/or system will provide for generating a referral fee agreement 206 on the real estate broker referral network platform 110 and/or customizing the referral fee agreement 206 based on particular features of the relationship between the referring real estate agent and/or broker (e.g., referring broker 106) and the referred real estate agent and/or broker (e.g., recipient broker 132). Further, the method and/or system will track the customized referral fee agreement 206 on the platform (e.g., using real estate broker referral network platform 110 of the real estate broker referral server 100) until such time that all parties to the agreement have either performed their obligations under the terms of the agreement and/or the agreement is cancelled and/or nullified.

According to another embodiment of this invention, the real estate broker referral network platform 110 may be configured to verify and obtain any licensing certifications for the referred real estate agent and/or broker (e.g., recipient broker 132) that may be required by the laws of each local jurisdiction in which the transaction is to take place.

This invention allows for users (e.g., client 112) and/or real estate brokers (e.g., referring broker 106, broker 124A-N, recipient broker 132) to contractually engage with one another on the online referral network platform (e.g., using real estate broker referral network platform 110 of the real estate broker referral server 100). The real estate broker referral network platform 110 enables the referring broker 106 and/or agent and the referred broker and/or agent (e.g., recipient broker 132) to enter into a legally binding contract in the form of a referral fee agreement 206 with each other in real estate markets that are located in different areas. The real estate broker referral network platform 110 allows for handling multiple contracting parties and/or resulting interactions and/or transactions on a large scale. This invention includes a tracking mechanism to monitor an exponential growth of contractual combinations integrated within the real estate broker referral network platform 110.

In a further embodiment, the referral fee agreement 206 generated using the real estate broker referral network platform 110 will include two main parties to the agreement, the referring broker 106 and the recipient broker 132. The client 112 being referred by the referring broker 106 may also be identified in the referral fee agreement 206 as a principal. In addition, the referral fee agreement 206 may also identify the referral fee and/or the duration of the agreement (using referral fee agreement 206 of the real estate broker referral server 100). Specifics of what services the recipient broker 132 provides for the principal may also be identified in the referral fee agreement 206. The referral fee agreement 206 may further include services to be provided by the recipient broker 132 such as selling and/or leasing a specific property in a specific time period, and/or buying a property within a specific time period.

In yet another embodiment, a crucial element of the referral fee agreement 206 may be the consideration given for the referral. The invention will enable the referring real estate agent and/or broker to negotiate with the recipient real estate agent and/or broker the amount of consideration to be paid for the referral. The referral fee may be expressed as a percentage of the gross commission received by the recipient broker 132 for services rendered to the referred client 112. For example, the referral fee may be 25% of the gross commission received. In other situations, the referral fee may be as high as 100%, for example, when a home builder has their own sales staff and will be making their profit from the sale of the new home. In other situations, the referral fee may be a fixed amount.

This invention enables the recipient broker 132 to customize how they would like to pay the consideration and/or enables the referring broker 106 to customize how they would like to receive the consideration. For example, the recipient broker 132 may ultimately be compensated in a foreign currency and/or digital currency and may wish to pay the consideration owed in the same form of currency. This invention will keep a distributed ledger system of all referral fees paid through the platform and automatically exchange the currency into the desired form of currency payment that the referring broker 106 has chosen to receive through the platform. This invention creates a global marketplace for referrals between real estate agents and/or brokers across different markets and allows real estate agents and/or brokers to dynamically list their prices for referrals in real time based on a number of considerations (e.g., their work flow, current influx of business, and/or current demand for services.) For example, a broker in San Francisco may have a client 112 needing to purchase a condominium in New York City. The San Francisco broker can utilize this invention to search and discover a qualified, authenticated, licensed, New York City Broker willing and able to accept client 112 referrals. A real estate broker referral network platform 110 search query could list multiple agents for the referral and the referring San Francisco broker could filter and sort the search results to find a well suited broker willing to pay the highest referral fee for the referral, thus providing maximum value to the referring broker 106.

This search and discovery process may further enable the referring broker 106 to select a recipient broker 132 based upon asymmetrical information that the referring broker 106 will have about the referred client 112 (e.g., the client 112's needs and/or desired location, price range, and/or type of property). The real estate broker referral network platform 110 will enable this client 112 information to be efficiently conveyed to the recipient broker 132. This enables the referring broker 106 to bypass other third party systems and select the desired recipient broker 132 themselves using the real estate broker referral network platform 110. Due to the nature of the real estate business, it is important to evaluate and/or assess the potential relationship that may be created by the transaction before entering into a formal arrangement. This invention makes it more efficient to consider this human interaction element by using the selection process that enables the referring broker 106 to systematically route real estate client 112 referrals to the most appropriate recipient real estate agent and/or broker.

Once a willing and able recipient broker 132 is identified, the referral fee agreement 206 can be drafted on the real estate broker referral network platform 110 using a computing device (e.g., using referral computing device 114A, 114B). The referring agent would be able to input the client(s) 112 information and/or other requirements (e.g., directly from his or her contacts) using a computing device (e.g., using referral computing device 114A, 114B). The referral computing device 114A, 114B may be a computer, a tablet, and/or a smart phone. The referral fee agreement 206 will then get auto-populated on the computing device of the relevant user(s) (e.g., the referring real estate agent and/or broker and/or the recipient real estate agent and/or broker). The resulting referral fee agreement 206 can then be fully executed by all parties digitally and securely in a matter of minutes, saving both time and money. Each referral fee agreement 206 will be assigned a unique ID (e.g., referral fee agreement unique ID 208) by the real estate broker referral network platform 110 which is used to track that particular referral fee agreement 206 within the system. With a fully executed referral fee agreement 206 in place, the referring broker 106 can then facilitate an introduction to the recipient broker 132 to provide the referred client 112 with the recipient broker's 132 services.

After the introduction has been made and the referred client 112 is working with the recipient broker 132, the recipient broker 132 may provide updates on the transaction using the real estate broker referral network platform 110 (e.g., itemize the properties shown, offers submitted, and/or offers received after a listing is on the market). This additional information may automatically trigger the real estate broker referral network platform 110 to send signals and/or notifications to the referring broker 106 through the real estate broker referral network platform 110. This will enable the referring broker 106 to better assess how the referred client 112 is being served and/or anticipate the referred client's 112 level of customer satisfaction and/or take any necessary steps to ensure that the referred client 112 will be satisfied.

Once there is a contract to purchase and/or sell real estate property relating to the terms of the referral agreement (e.g., referral fee agreement 206), the recipient broker 132 will provide this update relating to the transaction using the real estate broker referral network platform 110. For example, the recipient broker 132 may provide the escrow number and/or escrow officer contact information. The real estate broker referral network platform 110 may then use this information regarding the transaction to generate an automated broker demand to escrow which will have specific instructions enabling the real estate broker referral network platform 110 to track the referral fee payment process (e.g., using agreement status 302 of the real estate broker referral network platform 110). The broker demand will instruct escrow to wire a specific amount of funds from escrow to a platform controlled broker trust account. The funds wired from escrow, per the broker demand and instructions, will be associated with the referral fee agreement unique ID 208.

Once the wire has been received into the broker trust account, in the amount expected along with the unique referral fee agreement identifier 208, the system will be able to automatically disburse the funds as agreed upon in the referral fee agreement 206 and platform user agreement in the manner specified by the referring broker 106 (e.g., the referring broker 106 may choose to receive funds by check, wire, and/or ACH transfer). This automated payment process can increase the escrow payment cycle speed from a few business days from the close of escrow to a few banking hours from the close of escrow.

In a further embodiment, this invention allows for direct feedback to be given to the referring broker(s) 106 and/or agents for their client 112 referrals. The online referral network platform also has the flexibility for the brokers to direct the referral fee payments to their referring agents directly so that the brokers can receive passive income that does not need to be processed internally and then paid out to the agent per their compensation plan. This feature, if desired by the brokers, will then fully automate the payment process from start to finish. The referring broker 106 will be in full control of their referral fee payments and can customize how they wish to receive the payment.

The real estate broker referral network platform 110 will act as a market place for real estate referrals and also a clearing house for the referral payment process by tracking all funds transferred through the real estate broker referral network platform 110. The real estate broker referral network platform 110 thus automates the payment process. This process would comply with all IRS and/or local regulatory licensing agency requirements. Further, the real estate broker referral network platform 110 enables a more streamlined and efficient process while additionally providing for better monitoring of an entire transaction from start to finish.

In yet another embodiment, the real estate broker referral network platform 110 may authenticate (e.g., using broker verification 126) its users (e.g., recipient broker(s) 132) through their Multiple Listing Service (MLS) credentials and/or the National Association of Realtors database (e.g., using listed broker database 120 of the real estate broker referral network platform 110). The real estate broker referral network platform 110 may also enable real estate brokers and/or agents to communicate with each other, form groups, message, and/or blog. Each realtor that subscribes to the MLSs will have a unique MLS Identifier (e.g., broker ID 402), which can be searched. This unique MLS Identifier (e.g., broker ID 402) enables the referring broker 106 to see how many properties a particular broker (e.g., broker 124A-N) has sold from the last 12 months or up to 5 years. This unique MLS Identifier (e.g., broker ID 402) can be used by the real estate broker referral network platform 110 as a tool to authenticate (e.g., using broker verification 126) a broker 124A-N. The real estate broker referral network platform 110 may also have a broker's profile listing (e.g., broker profile 404) how many properties that particular broker has sold, how many buyers they have represented, what types of properties they have sold, and/or personalized reviews from their customers (e.g., client 112).

This invention enables a free flow exchange of referrals, forming contractual agreements (e.g., referral fee agreement 206), monitoring the whole process (e.g., using agreement status 302 of the real estate broker referral network platform 110), reviewing current and/or prior transactions, and/or giving reviews (e.g., using give rating 406 of the real estate broker referral network platform 110) relating to a particular transaction and/or real estate agent and/or broker.

In one example embodiment, a method includes providing an interface (e.g., real estate broker referral network platform 110) through which a referring broker 106 selects a recipient broker 132 chosen among a set of brokers (e.g., broker 124A-N) in a second jurisdiction (e.g., second real estate market space 122) different than a first jurisdiction (e.g., first real estate market space 108) in which the referring broker 106 is licensed. The method automatically populates a set of information (e.g., referral agreement criteria 202, agreement negotiation criteria 204) in a referral contract (e.g., referral fee agreement 206) between the referring broker 106 and the recipient broker 132 includes party names, a referred client name, a term limit, a commission percentage, a territory, an exclusivity parameter, and/or a set of governing terms based on a set of criteria provided by the referring broker 106 (e.g., referral agreement criteria 202) and the recipient broker 132 (e.g., agreement negotiation criteria 204) using a processor 104 and a memory 102.

The method determines that the referred client 112 has entered into an escrow associated with a sale of a real property, a purchase of the real property, and/or a lease of the real property with the recipient broker 132 with an escrow provider. In addition, the method automatically communicates the referral contract (e.g., referral fee agreement 206) between the referring broker 106 and the recipient broker 132 to the escrow provider. Further, the method requests the escrow provider to provide a consideration based on the commission percentage to the referring broker 106 at a close of escrow associated with the sale of the real property, the purchase of the real property, and/or the lease of the real property. The method further credits the consideration in a banking account of the referring broker 106 upon the close of the escrow of associated with the sale of the real property, the purchase of the real property, and/or the lease of the real property.

In another example embodiment, a method of contracting real estate broker referrals over a network 105 includes providing a real estate broker referral application (e.g., real estate broker referral network platform 110) to a user (e.g., referring broker 106, recipient broker 132, broker 124A-N) for installation on a user device (e.g., referral computing device 114A, 114B). The user is a real estate broker (e.g., referring broker 106, recipient broker 132, broker 124A-N). The method includes receiving authentication (e.g., broker verification 126) of a license and/or a registration of the user (e.g., referring broker 106, recipient broker 132, broker 124A-N) at a server (e.g., real estate broker referral server 100) sent from a data source over the Internet. The transmission server (e.g., referring broker 106, recipient broker 132, broker 124A-N) includes a processor 104 and a memory 102.

The method receives a request from a referring user (e.g., referring broker 106) to identify at least one authenticated recipient user (e.g., recipient broker 132) at the server recipient broker 132. The referring user (e.g., referring broker 106) is active in a first real estate market space 108. The at least one authenticated recipient user (e.g., referring broker 106) is active in a second real estate market space 122. A client 112 of the referring user (e.g., referring broker 106) needs to sell, buy and/or lease a property in the second real estate market space 122. The processor 104 identifies the at least one authenticated recipient user (e.g., referring broker 106) based on the request. The processor 104 transmits the identification to the user device (e.g., referral computing device 114A, 114B) of the referring user (e.g., referring broker 106).

The identification activates the real estate broker referral application (e.g., real estate broker referral network platform 110) to cause the identification to display on the user device (e.g., real estate broker referral network platform 110) of the referring user (e.g., referring broker 106). The processor generates a contract (e.g., referral fee agreement 206) based on a selection of a specific authenticated recipient user (e.g., referring broker 106) by the referring user (e.g., referring broker 106). The contract (e.g., referral fee agreement 206) is between the specific authenticated recipient user (e.g., recipient broker 132) and the referring user (e.g., referring broker 106).

The processor 104 transmits the contract (e.g., referral fee agreement 206) to the user device (e.g., referral computing device 114A) of the referring user (e.g., referring broker 106) and the user device (e.g., referral computing device 114B) of the specific authenticated recipient user (e.g., referral computing device 114B). The contract (e.g., referral fee agreement 206) activates the real estate broker referral application (e.g., real estate broker referral network platform 110) to cause the contract (e.g., referral fee agreement 206) to display on the user device (e.g., referral computing device 114A) of the referring user and the user device (e.g., referral computing device 114B) of the specific authenticated recipient user (e.g., referral computing device 114B). The contract (e.g., referral fee agreement 206) is signed by the referring user (e.g., referral computing device 114A) and the authenticated recipient user (e.g., recipient broker 132). The processor 104 stores the signed contract (e.g., referral fee agreement 206) on the server (e.g., real estate broker referral server 100).

Example embodiments, as described below, may be used to provide a system, device and/or an apparatus of a real estate broker referral network platform. Although, the present embodiments have been described with reference to specific example embodiments, it will be evident that various modifications and changes may be made to these embodiments without departing from the broader spirit and scope of the various embodiments.

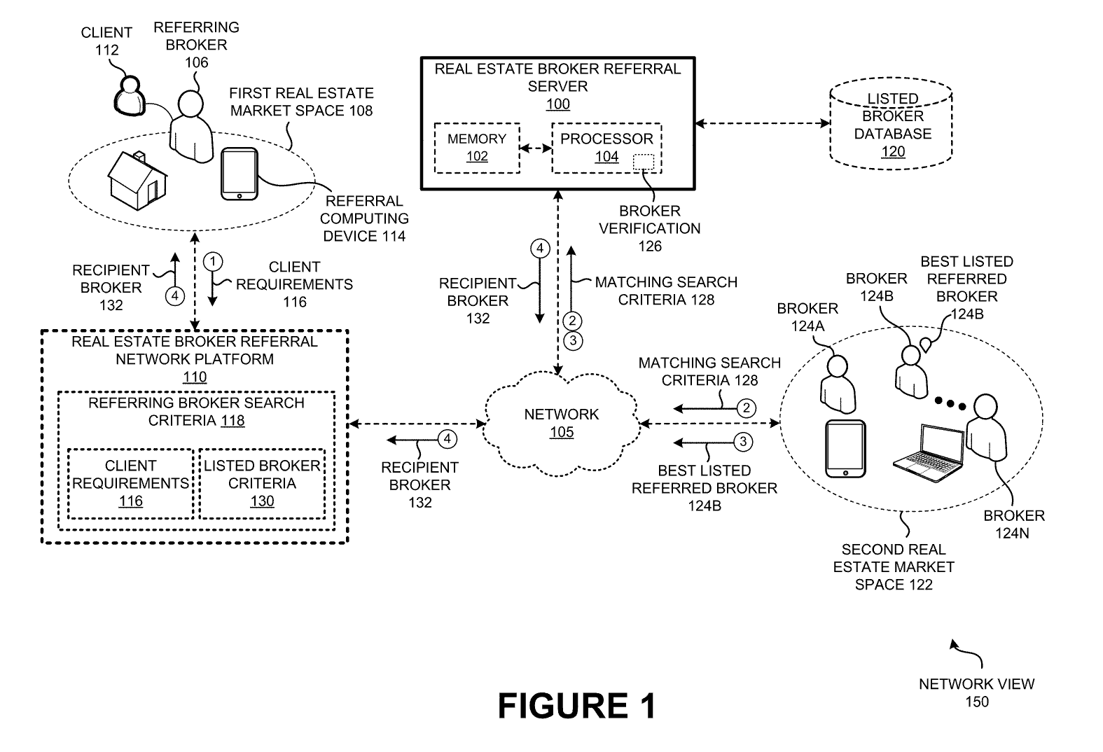

FIG. 1 is a network view 150 illustrating the search and verification of a recipient broker 132 by a referring broker 106 using a real estate broker referral network platform 110 based on the referring broker search criteria 118 of the real estate broker referral server 100, according to one embodiment.

Particularly, FIG. 1 shows a real estate broker referral server 100, a memory 102, a processor 104, a network 105, a referring broker 106, a first real estate market space 108, a real estate broker referral network platform 110, a client/principal 112, a referral computing device 114, client requirements 116, a referring broker search criteria 118, a listed broker database 120, a second real estate market space 122, broker 124(A-N), a broker verification 126, a matching search criteria 128, a listed broker criteria 130, and a recipient broker 132, according to one embodiment.

The real estate broker referral server 100 may be a computer and/or a computing device on a network (e.g., network 105) that manages network resources to enable creating a search and discovery platform for real estate agents and/or brokers to search and discover one another for the purpose of sending and/or receiving client referrals in exchange for referral fees. In an example embodiment, the real estate broker referral server 100 may be a computer program designed for sharing data and/or software resources used to generate a referral fee agreement 206 based on particular features of the relationship between the referring real estate agent and/or broker (e.g., referring broker 106) and the referred real estate agent and/or broker (e.g., recipient broker 132) of different real estate markets located anywhere the world by using a computing device (e.g., referral computing device 114A, 114B). Further, the real estate broker referral server 100 may manage tracking the customized referral fee agreement 206 and/or ensure all parties to the agreement performed their obligations under the terms of the agreement, according to one embodiment.

The memory 102 may be any physical device used for storing information temporarily and/or permanently for immediate use by the processor 104 of the real estate broker referral server 100. Further, the memory 102 may be a volatile memory that stores information on an integrated circuit used by the operating system, software, and hardware of the real estate broker referral server 100. The processor 104 may be a logic circuitry that responds to and processes the basic instructions to drive the search and discovery of the real estate agents and/or brokers mutually in the real estate broker referral network platform 100, according to one embodiment.

The network 105 may be a group of two or more computer systems linked together through communication channels (e.g., wired and/or wireless) to facilitate communication and resource-sharing among a wide range of users (e.g., referring broker 106, broker 124A-N) using network media devices (e.g., referral computing device 114A, 114B) of the real estate broker referral network platform 100, according to one embodiment.

The referring broker 106 may be a person acting on behalf of a client 112 (e.g., principal) needing to buy, rent, lease, and/or sell a property in a different real estate market space (e.g., second real estate market space 122). The referring broker 106 may be a real estate agent active located and/or licensed in the first real estate market space 108. The referring broker 106 may direct the client 112 (e.g., principal) to a qualified, authenticated, licensed broker (e.g., best listed broker 124B, recipient broker 132) actively willing to serve the client 112 (e.g., principal) and entering into a referral fee agreement 206 through the real estate broker referral network platform 110 for its referral, according to one embodiment.

In another example embodiment, the referring broker 106 may be any licensed agent, realtor, and/or a licensed real estate broker having a unique NRDS number and eligible for dealing in real estate market space, but may not be actively practicing in the real estate business outside of giving client referrals.

The first real estate market space 108 may be a center for sale and/or purchase of property comprised of land and buildings on it where the referring broker 106 is engaged in dealing, according to one embodiment.

The real estate broker referral network platform 110 may be an underlying computer system on which application programs to search, discover, negotiate, and deal with real estate brokers of different market space can run. The real estate broker referral network platform 110 may enable real estate brokers of different market space to register, form profiles, and authenticate its users (e.g., registered brokers). Further, the real estate broker referral network platform 110 may help real estate brokers and/or agents get introduced, give them the ability to interact contractually, set their price, and/or negotiate the terms of referral fee agreement 206 with other real estate brokers and/or agents, according to one embodiment.

In another embodiment, the processor 104 of the real estate broker referral server 100 may be configured to verify and obtain any licensing certifications for the referred real estate agent and/or broker using the real estate broker referral network platform 110.

Further, the real estate broker referral network platform 110 may enable the brokers (e.g., referring broker 106, recipient broker 132) to review a particular broker's profile using a rating tab (e.g., give rating 406). In another embodiment, the real estate broker referral network platform 110 may enable the recipient broker 132 to update an agreement status 302 using the update status 304 tab. The real estate broker referral network platform 110 may facilitate brokers to be in more control of the process of dealing in the real estate market, according to one embodiment.

The client 112 may be a person, group of persons, a firm, a company, an agency and/or an establishment which authorizes an agent (e.g., a referring broker 106) to act on its behalf to search and negotiate with another party (e.g., a receiving broker 132). The client 112 (e.g., principal) may give the referring broker 106 his authority to act and to make decisions. The client/principal 112 may not typically make day-to-day decisions, but is legally the owner of the business and can give direction to the referring broker 106 acting on his/her behalf, according to one embodiment. The client 112 being referred by the referring broker 106 may also be identified in the referral fee agreement 206 as a principal, according to one embodiment.

The referral computing device 114A, 114B may be a programmable machine responding to a specific set of instructions in a well-defined manner and execute prerecorded instructions used for communication by the referring broker 106 and/or the recipient broker 132 with real estate broker referral network platform 110, according to one embodiment. In an example embodiment, referral computing device 114A, 114B may be a desktop computer, a smartphone, a laptop, a tablet, etc., according to one embodiment.

The client requirements 116 may be the specific conditions and/or demands of the client 112 based on which the receiving broker 132 is searched and discovered in the real estate broker referral network platform 110. The client requirements 116 may include the geographic area, state, or city in which the client 112 wishes to buy, sell, rent, or lease a property, a type of property (e.g., residential, commercial, agricultural, or industrial), price range of the property, and/or an estimated time frame within which the client 112 wishes to complete the process, according to one embodiment.

The referring broker search criteria 118 may be the standard requests and/or demands of a client 112 that form the basis of hunting for a receiving broker 132. The referring broker search criteria 118 may include the client requirements 116, rating of the broker, and willingness to pay maximum brokerage for the referral within a specific time. The listed broker database 120 may be a collection of information of authenticated and legally qualified real estate brokers that is organized so that it can easily be accessed, managed, and updated by the processor 104 of the real estate broker referral server 100. The listed broker database 120 may include all the information about verified licensed real estate agents/brokers along with their ratings, according to one embodiment.

The second real estate market space 122 may be a center for sale and/or purchase of property comprised of land and buildings on it where the recipient broker 106 is engaged in dealing. The broker 124(A-N) may be a person, a firm, company, and/or an organization dealing in the second real estate market space 122 receiving a referral for serving the client 112 from the referring broker 106, according to one embodiment.

The broker verification 126 may be a process of establishing the authenticity of a person, a firm, a company, and/or an organization as dealer in a real estate market space (e.g., first real estate market space 108, second real estate market space 122). The broker verification 126 for a particular broker may be accomplished using the Multiple Listing Service (MLS) credentials and/or the national association of realtor's database. Each realtor that subscribes to the MLSs will have a unique MLS Identifier, which can be searched using the real estate broker referral network platform 110. This unique MLS Identifier enables the referring broker 106 to see how many property a particular broker has sold from last 12 months for up to 5 years. This unique MLS Identifier may be used as a tool to authenticate a broker, according to one embodiment.

The matching search criteria 128 may be the corresponding standard caliber of the recipient broker 106 that form the basis of referring the client 112 to the recipient broker 132. The listed broker criteria 130 may be conditions put-in-forth by the recipient broker 132 for accepting the referral of the referring broker 106, according to one embodiment.

The recipient broker 132 may be a person, a firm, company, and/or an organization dealing in the second real estate market space 122 competent and efficient enough to receive a referral for serving the client/principal 112 from the referring broker 106 based on the referring broker search criteria 118. The recipient broker 132 may be a person, a firm, a company, and/or an organization willing to pay the highest referral fee in exchange of the referral, according to one embodiment.

For example, a broker who is more in need of the business may offer 40% referral fee and the broker who is really busy and doesn't need the business may only offer a 10% referral fee. The real estate broker referral network platform 110 may enable the referring broker 106 and the recipient broker 132 to simplify the process of entering into the referral fee agreement 206 by eliminating the need for heavy negotiations regarding the amount of the referral fee as a result of the recipient broker 132 being able to dynamically list their offered referral fee based on their current circumstances. The recipient broker 132 may list their price and create a market place for these referrals using the real estate broker referral network platform 110. For example, the services of the recipient broker 132 may be in high demand allowing the recipient broker 132 to list a lower referral fee (e.g., a 10% referral fee) on the real estate broker referral network platform 110. In another example, the services of the recipient broker 132 may be in low demand (e.g., there is a higher concentration of brokers and/or agents and therefore more competition) and more eager to receive a referral, in which case the recipient broker 132 may offer a higher referral fee as consideration for the referral (e.g., a 40% or 50% referral fee.) The recipient broker 132 who is in low demand may be just as capable of offering a comparable satisfaction rating to that of the recipient broker 132 in high demand, in which case the referring broker 106 may decide to choose the recipient broker 132 offering the higher referral fee in a given instance, according to one embodiment. The real estate broker referral network platform 110 may facilitate the referring broker 106 to make this choice and route the referral to the recipient broker 110 offering the highest referral fee as consideration for the referral rather than routing the referral to another broker and/or agent with comparable skills and services who is offering to pay a lower referral fee, according to one embodiment.

The real estate broker referral network platform 110 allows the referral fee agreement(s) 206 to adapt to and/or reflect the current market forces in a given area. In one example embodiment, the second real estate market space 122 may have a high concentration of brokers and/or agents resulting in more competition which may drive the recipient broker(s) 110 in that area to list a referral fee that is higher than an average market rate. In another example embodiment, the listings in the second real estate market space 122 may be for a higher dollar amount which may allow the recipient broker(s) 110 to list a smaller referral fee, according to one embodiment.

By enabling the recipient broker(s) 110 to dynamically list their referral fee based on their own personal circumstances and/or current market forces in their area, the real estate broker referral network platform 110 is able to remove the negotiation process out of the overarching process of entering into the referral fee agreement 206, while still addressing the needs of the parties at any given point in time. For example, two identical searches for recipient broker(s) 110 conducted at two distinct points in time may result in different filtering and/or sorting search results based on the referral fee offered since each individual referring broker 110 are able to dynamically list the referral fee they are offering at any given time. For example, as a recipient broker 110 gains more experience with time and/or with each additional confirmed sale, their perceived value may increase enabling the same recipient broker to offer a lower referral fee at a later time (e.g., a new recipient broker 110 may offer a 50% referral fee when they first start, but they may reduce the fee a year later to 40% to reflect their gained knowledge and/or experience), according to one embodiment.

FIG. 1 shows in circle ‘1’, the referring broker 106 may search for a best listed broker 124(A-N) in the real estate broker referral network platform 110 as per client requirements 116 using the referral computing device 114A. The client requirements 116 may be sent to the real estate broker referral server 100. In circle ‘2’, the matching search criteria 128 of the brokers 124(A-N) active in the second real estate market space 122 may be sent by the real estate broker referral server 100 to the real estate broker referral network platform 110 through the network 105, according to one embodiment.

In circle ‘3’, the real estate broker referral server 100 may identify the best listed broker 124B active in the second real estate market space 122. In circle ‘4’, the referring broker 106 may accept the best listed broker 124B as a recipient broker in the real estate broker referral network platform 110, according to one embodiment.

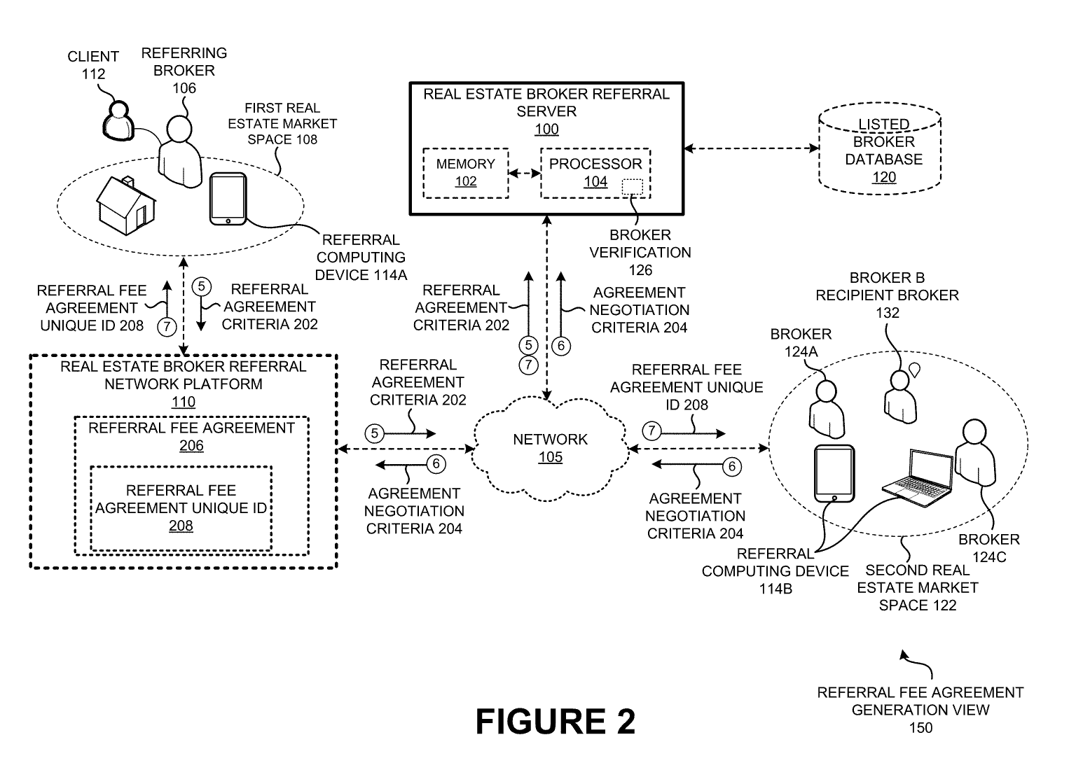

FIG. 2 is a network view 250 illustrating the generation of a referral fee agreement 206 between the referring broker 106 and the recipient broker 132 in the real estate broker referral network platform 110 based on the referral agreement criteria 202 of the referring broker 106 of the real estate broker referral server 100 of FIG. 1, according to one embodiment.

Particularly, FIG. 2 builds on FIG. 1, and further adds a referral agreement criteria 202, an agreement negotiation criteria 204, a referral fee agreement 206, and a referral fee agreement unique ID 208, according to one embodiment.

The referral agreement criteria 202 may be the conditions forming the basis of the referral fee agreement 206. The referral agreement criteria 202 may include the geographic region, state, or city in which the client 112 is required to be served, type of property, price range, and/or the time frame by which the client 112 is willing to buy/sell the property. The referral agreement criteria 202 may also include the maximum brokerage that needs to be paid for a particular referral, according to one embodiment.

The agreement negotiation criteria 204 may be conditions proposed by the best listed broker 124B for entering into a contractual agreement with the referring broker 106. The agreement negotiation criteria 204 may include the highest brokerage he may be willing to pay, time frame and/or validity period of the agreement, a minimum number of properties to be shown for an agreement, and/or a minimum number of offers to be submitted, according to one embodiment.

The referral fee agreement 206 may be a legally enforceable understanding between the referring broker 106 and a receiving broker 132. The referral fee agreement 206 may be obligatory for the parties entering into it (e.g., referring broker 106 and the recipient broker 132). The referral fee agreement 206 may include a stipulated referral fee, validity period of the agreement, conditions and/or terms, non-compliance of which by any one of the parties involved may make the referral fee agreement 206 canceled and/or void, according to one embodiment.

The referral fee agreement unique ID 208 may be a distinct sequence of characters used to identify a referral fee agreement 206 to allow tracking and monitoring of a referral fee agreement 206 by different parties to the agreement in the real estate broker referral network platform 110, according to one embodiment.

FIG. 2 shows in circle ‘5’, the referring broker 106 may enter referring agreement criteria 202 in the real estate broker referral network platform 110 using the referral computing device 114A. In circle ‘6’, the recipient broker 132 may enter the agreement negotiation criteria 204 in the real estate broker referral network platform 110 using the referral computing device 114B through the network 105. In circle ‘7’, the referral fee agreement unique ID 208 generated in the real estate broker referral network platform 110 may be sent to the recipient broker 132 and the referring broker 106 by the real estate broker referral server 100 through the network 105, according to one embodiment.

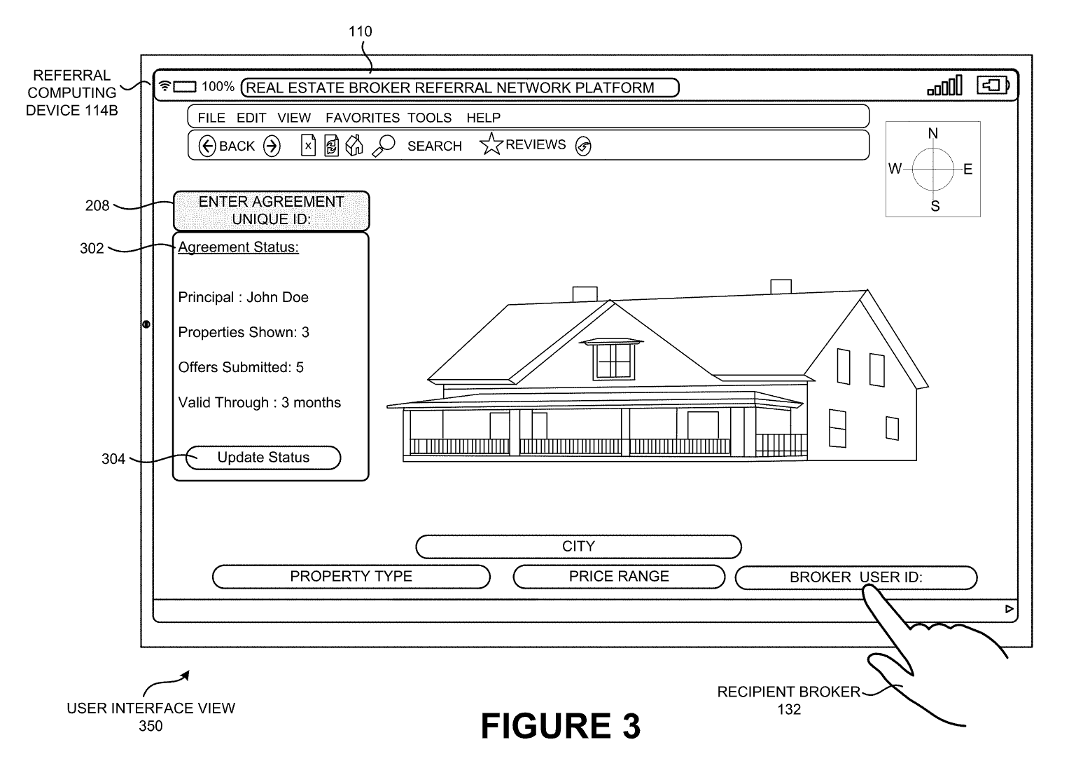

FIG. 3 is a user interface view 350 illustrating the recipient broker 132 updating the agreement status 302 in the real estate broker referral network platform 110 of the real estate broker referral server 100 of FIG. 1, according to one embodiment.

Particularly, FIG. 3 builds on FIG. 1 and FIG. 2, and further adds agreement status 302 and update status 304, according to one embodiment.

The agreement status 302 may be the existing situation of a referral fee agreement 206 giving the most up-to-date information of the corresponding referral fee agreement 206. The agreement status 302 may enable the referring broker 106 to review and/or monitor the present situation of a particular referral fee agreement 206 by entering the referring fee agreement unique ID 208 in the corresponding unique ID field. This may enable referring broker 106 to see if the referred client 112 is being well served. The update status 304 may be a tab in the real estate broker referral network platform 110 that enables recipient broker 132 to enter the latest information regarding a particular referral fee agreement 206, according to one embodiment.

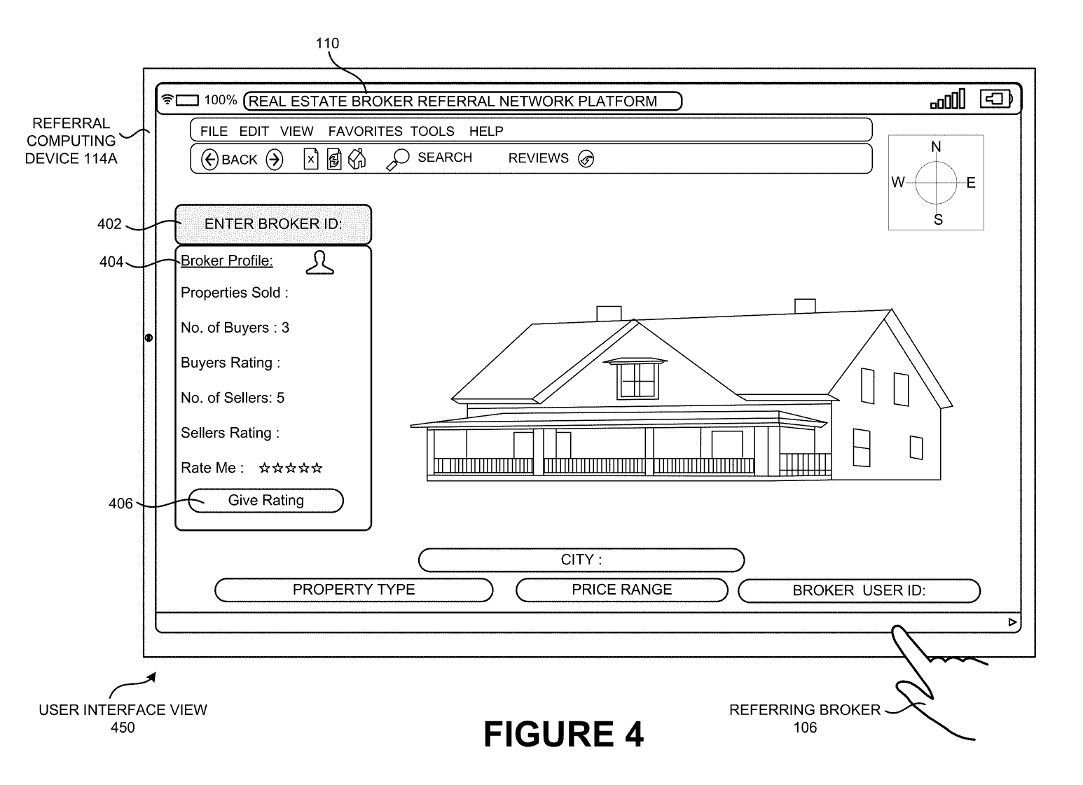

FIG. 4 is a user interface view 450 illustrating the reviewing of the multiple listing service status of a registered broker based on unique broker ID in the real estate broker referral network platform 110 of the real estate broker referral server 100 of FIG. 1, according to one embodiment.

Particularly, FIG. 4 builds on FIGS. 1, 2, and 3, and further adds broker ID 402, a broker profile 404, and a give rating 406, according to one embodiment. The broker ID 402 tab may enable any registered broker (e.g., referring broker 106) to search and authenticate a particular broker's profile in the real estate broker referral network platform 110.

Once a registered broker enters a unique ID of a particular broker in the broker ID 402 tab of the real estate broker referral network platform 110, the registered broker (e.g., referring broker 106) may be able to see how many sellers this particular broker has represented, how many properties he has sold, how many buyers he has represented, and what types of properties he has listed. There may be lot of different characteristics that are published on a particular broker's profile, according to one embodiment.

In another embodiment, a registered broker (e.g., referring broker 106) may give review and/or ranking using a give rating 406 tab in the real estate broker referral network platform 110. The rating may be based on various criteria, such as whether the receiving broker has served the client well, updated the current status on the real estate broker referral network platform 110 in real-time, and honored the referral fee agreement 206 within stipulated time. In other words, the ‘Rate Me’ tab of the broker profile 404 may reflect the customer satisfaction of a receiving broker 132 and/or a referring broker 106 based on their performance.

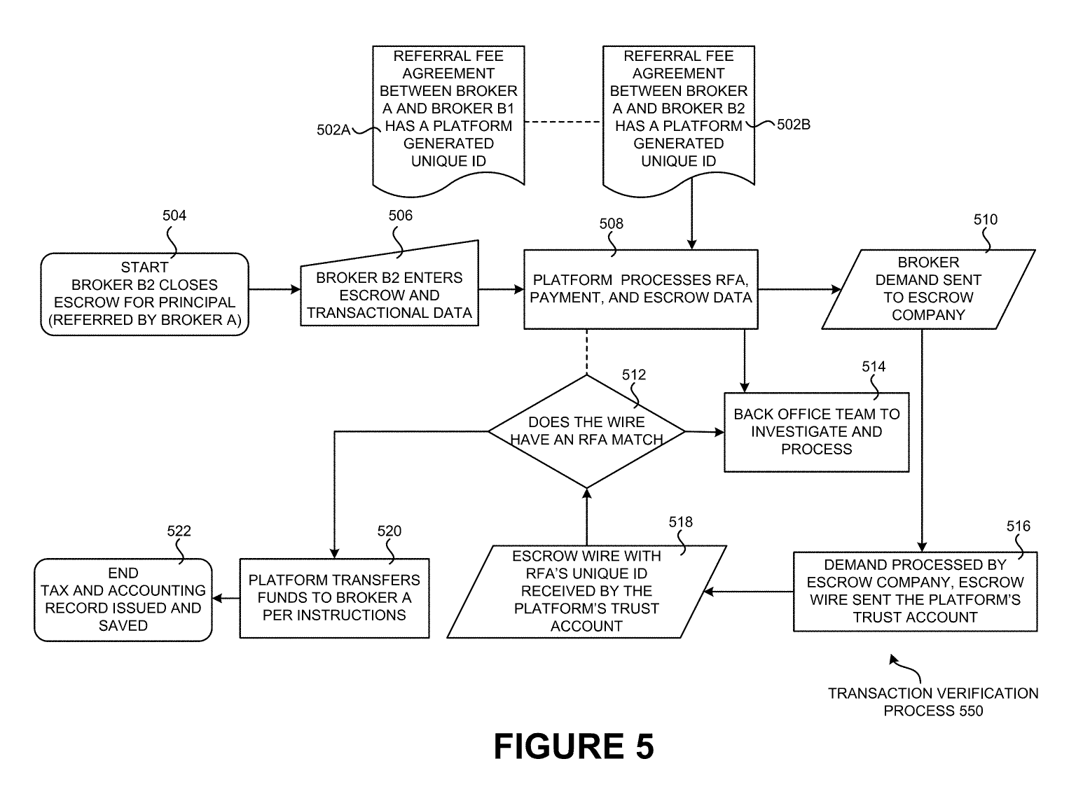

FIG. 5 is a graphical process flow view 550 illustrating the transaction verification process of the real estate broker referral server 100 of FIG. 1, according to one embodiment.

In operation 502A, the referral fee agreement 206 between broker A and broker B1 may be assigned a real estate broker referral network platform 110 generated unique ID. In operation 502B, the referral fee agreement 206 between broker A and broker B1 may be assigned a real estate broker referral network platform 110 generated unique ID.

In operation 504, broker B2 may close an escrow for the client 112 (e.g., principal) referred by broker A (e.g., referring broker 106). In operation 506, broker B2 may enter escrow and transactional data in the real estate broker referral network platform 110 using the update status 304 tab. In operation 508, the real estate broker referral network platform 110 may process the referral fee agreement 206, payment, and escrow data, according to one embodiment.

In operation 510, broker demand may be sent to the escrow company by the real estate broker referral server 100. In operation 512, the real estate broker referral server 100 may verify if the wire have a referral fee agreement 206 match. In operation 514, back office team may investigate and process the escrow data, according to one embodiment.

In operation 516, the real estate broker referral server 100 may verify the demand processed by Escrow Company and the escrow wire sent to the real estate broker referral network platform's 100 trust account. In operation 518, escrow wire with referral fee agreement unique ID 208 is received by the real estate broker referral network platform's 100 trust account, according to one embodiment.

In operation 520, the real estate broker referral network platform 110 may transfer funds to broker A (e.g., referring broker 106) per instructions. In operation 522, tax and accounting record may be issued and saved by the real estate broker referral server 100, according to one embodiment.

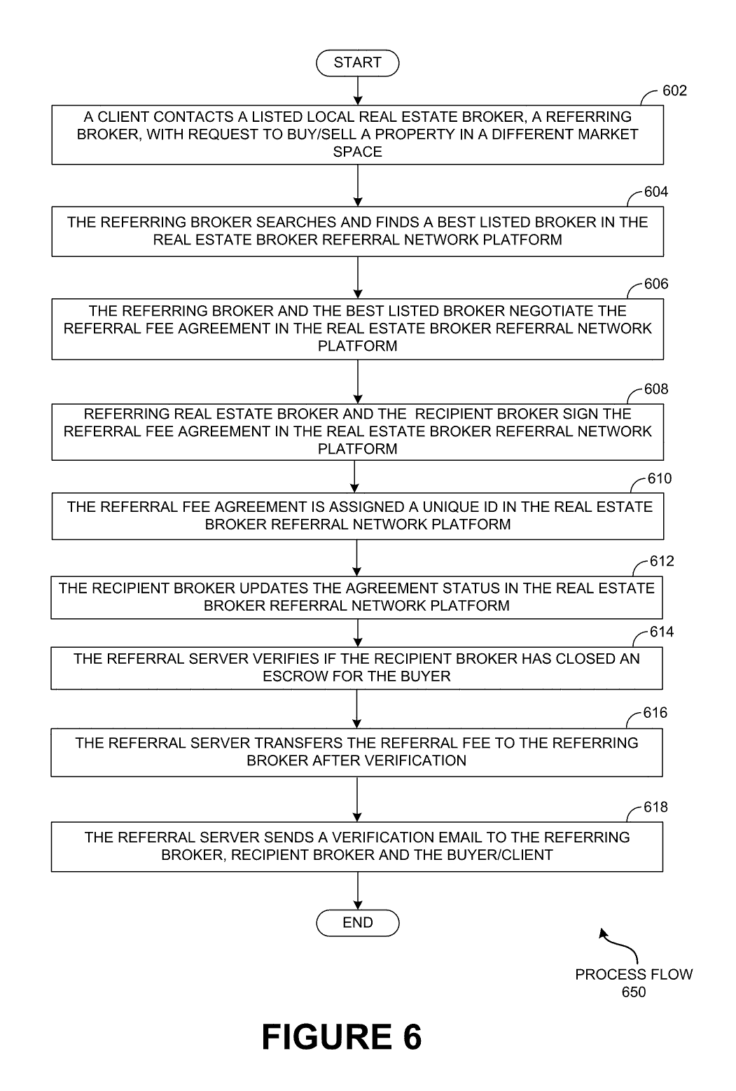

FIG. 6 is a process flow 650 detailing the operations involved in generation of a referral fee agreement 206 between a referring broker 106 and a recipient broker 132 in a real estate broker referral network platform 110 and verification of transfer of referral fee by the real estate broker referral server 100 of FIG. 1, according to one embodiment.

In operation 602, the client 112 (e.g., principal) may contact a referring broker 106 active in one real estate market space 108 with a request to buy/sell a property in a second real estate market space 122. In operation 604, the referring broker 106 may search and find a best listed broker 124B in the real estate broker referral network platform 110 using a referral computing device 114A. In operation 606, the referring broker 106 and the best listed broker 124B in the real estate broker referral network platform 100 may negotiate a referral fee agreement 206 in the real estate broker referral network platform 110, according to one embodiment.

In operation 608, the referring broker 106 and the recipient broker 132 may sign the referral fee agreement 206 in the real estate broker referral network platform 110. In operation 610, the referral fee agreement 206 may be assigned a unique ID (e.g., referral fee agreement unique ID 208) in the real estate broker referral network platform 110. In operation 612, the recipient broker 132 may update the agreement status 302 in the real estate broker referral network platform 110, according to one embodiment.

In operation 614, the real estate broker referral server 100 may verify if the recipient broker 132 has closed an escrow for the client 112 (e.g., principal). In operation 616, the real estate broker referral server 100 may transfer the referral fee to the referring broker 106 after verification. In operation 618, the real estate broker referral server 100 may send a verification email to the referring broker 106, recipient broker 132 and the client 112, according to one embodiment.

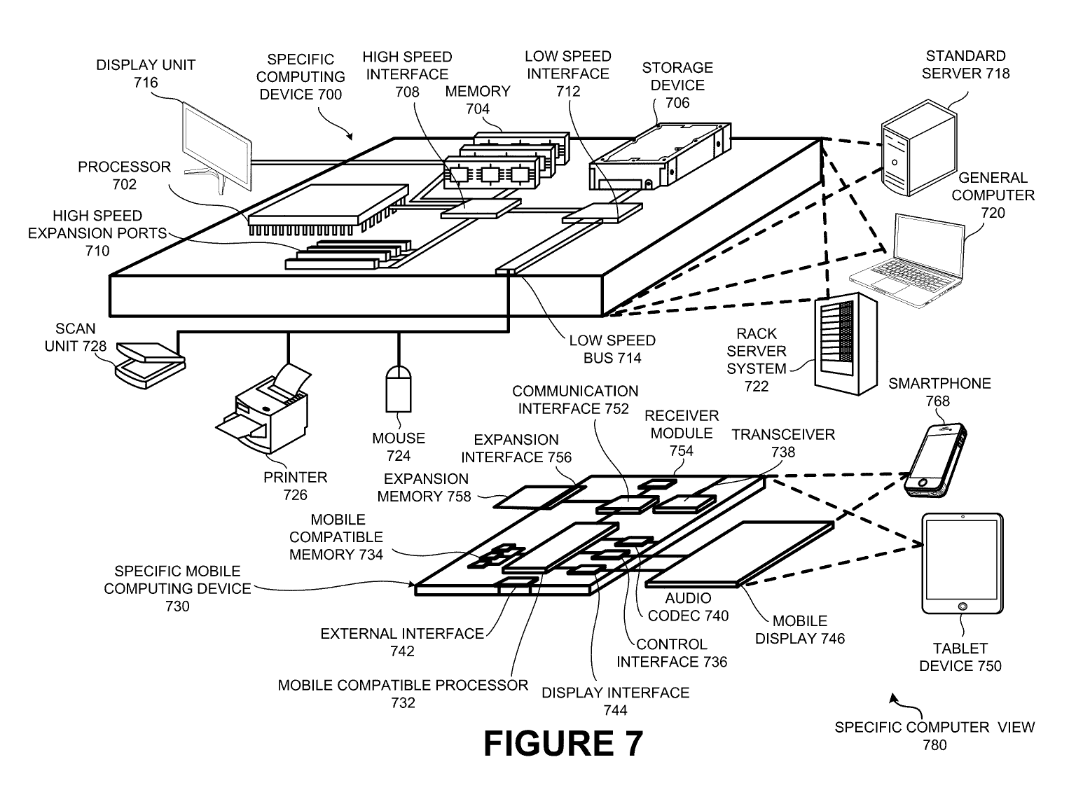

FIG. 7 is a schematic diagram of specific computing device 780 and a specific mobile computing device 730 that can be used to perform and/or implement any of the embodiments disclosed herein. In one or more embodiments, the real estate broker referral server 100 and/or the referral computing device(s) 114(A-N) illustrated in FIG. 1 may be the specific computing device 700.

The specific computing device 700 may represent various forms of digital computers, such as laptops, desktops, workstations, personal digital assistants, servers, blade servers, mainframes, and/or other appropriate computers. The specific mobile computing device 730 may represent various forms of mobile devices, such as smartphones, camera phones, personal digital assistants, cellular telephones, and other similar mobile devices. The components shown here, their connections, couples, and relationships, and their functions, are meant to be exemplary only, and are not meant to limit the embodiments described and/or claimed, according to one embodiment.

The specific computing device 700 may include a processor 702, a memory 704, a storage device 706, a high speed interface 708 coupled to the memory 704 and a plurality of high speed expansion ports 710, and a low speed interface 712 coupled to a low speed bus 714 and a storage device 706. In one embodiment, each of the components heretofore may be inter-coupled using various buses, and may be mounted on a common motherboard and/or in other manners as appropriate. The processor 702 may process instructions for execution in the specific computing device 700, including instructions stored in the memory 704 and/or on the storage device 706 to display a graphical information for a GUI on an external input/output device, such as a display unit 716 coupled to the high speed interface 708, according to one embodiment.

In other embodiments, multiple processors and/or multiple buses may be used, as appropriate, along with multiple memories and/or types of memory. Also, a plurality of computing device 700 may be coupled with, with each device providing portions of the necessary operations (e.g., as a server bank, a group of blade servers, and/or a multi-processor system).

The memory 704 may be coupled to the specific computing device 700. In one embodiment, the memory 704 may be a volatile memory. In another embodiment, the memory 704 may be a non-volatile memory. The memory 704 may also be another form of computer-readable medium, such as a magnetic and/or an optical disk. The storage device 706 may be capable of providing mass storage for the specific computing device 700. In one embodiment, the storage device 706 may be includes a floppy disk device, a hard disk device, an optical disk device, a tape device, a flash memory and/or other similar solid state memory device. In another embodiment, the storage device 706 may be an array of the devices in a computer-readable medium previously mentioned heretofore, computer-readable medium, such as, and/or an array of devices, including devices in a storage area network and/or other configurations.

A computer program may be comprised of instructions that, when executed, perform one or more methods, such as those described above. The instructions may be stored in the memory 704, the storage device 706, a memory coupled to the processor 702, and/or a propagated signal.

The high speed interface 708 may manage bandwidth-intensive operations for the specific computing device 700, while the low speed interface 712 may manage lower bandwidth-intensive operations. Such allocation of functions is exemplary only. In one embodiment, the high speed interface 708 may be coupled to the memory 704, the display unit 716 (e.g., through a graphics processor and/or an accelerator), and to the plurality of high speed expansion ports 710, which may accept various expansion cards.

In the embodiment, the low speed interface 712 may be coupled to the storage device 706 and the low speed bus 714. The low speed bus 714 may be comprised of a wired and/or wireless communication port (e.g., a Universal Serial Bus (“USB”), a Bluetooth® port, an Ethernet port, and/or a wireless Ethernet port). The low speed bus 714 may also be coupled to the scan unit 728, a printer 726, a keyboard, a mouse 724, and a networking device (e.g., a switch and/or a router) through a network adapter.

The specific computing device 700 may be implemented in a number of different forms, as shown in the figure. In one embodiment, the computing device 700 may be implemented as a standard server 718 and/or a group of such servers. In another embodiment, the specific computing device 700 may be implemented as part of a rack server system 722. In yet another embodiment, the specific computing device 700 may be implemented as a general computer 720 such as a laptop or desktop computer. Alternatively, a component from the specific computing device 700 may be combined with another component in a specific mobile computing device 730. In one or more embodiments, an entire system may be made up of a plurality of specific computing device 700 and/or a plurality of specific computing device 700 coupled to a plurality of specific mobile computing device 730.

In one embodiment, the specific mobile computing device 730 may include a mobile compatible processor 732, a mobile compatible memory 734, and an input/output device such as a mobile display 746, a communication interface 752, and a transceiver 738, among other components. The specific mobile computing device 730 may also be provided with a storage device, such as a microdrive or other device, to provide additional storage. In one embodiment, the components indicated heretofore are inter-coupled using various buses, and several of the components may be mounted on a common motherboard.

The mobile compatible processor 732 may execute instructions in the specific mobile computing device 730, including instructions stored in the mobile compatible memory 734. The mobile compatible processor 732 may be implemented as a chipset of chips that include separate and multiple analog and digital processors. The mobile compatible processor 732 may provide, for example, for coordination of the other components of the specific mobile computing device 730, such as control of user interfaces, applications run by the specific mobile computing device 730, and wireless communication by the specific mobile computing device 730.

The mobile compatible processor 732 may communicate with a user through the control interface 736 and the display interface 744 coupled to a mobile display 746. In one embodiment, the mobile display 746 may be a Thin-Film-Transistor Liquid Crystal Display (“TFT LCD”), an Organic Light Emitting Diode (“OLED”) display, and another appropriate display technology. The display interface 744 may comprise appropriate circuitry for driving the mobile display 746 to present graphical and other information to a user. The control interface 736 may receive commands from a user and convert them for submission to the mobile compatible processor 732.

In addition, an external interface 742 may be provide in communication with the mobile compatible processor 732, so as to enable near area communication of the specific mobile computing device 730 with other devices. External interface 742 may provide, for example, for wired communication in some embodiments, or for wireless communication in other embodiments, and multiple interfaces may also be used.

The mobile compatible memory 734 may be coupled to the specific mobile computing device 730. The mobile compatible memory 734 may be implemented as a volatile memory and a non-volatile memory. The expansion memory 758 may also be coupled to the specific mobile computing device 730 through the expansion interface 756, which may comprise, for example, a Single In Line Memory Module (“SIMM”) card interface. The expansion memory 758 may provide extra storage space for the specific mobile computing device 730, or may also store an application or other information for the specific mobile computing device 730.

Specifically, the expansion memory 758 may comprise instructions to carry out the processes described above. The expansion memory 758 may also comprise secure information. For example, the expansion memory 758 may be provided as a security module for the specific mobile computing device 730, and may be programmed with instructions that permit secure use of the specific mobile computing device 730. In addition, a secure application may be provided on the SIMM card, along with additional information, such as placing identifying information on the SIMM card in a non-hackable manner.

The mobile compatible memory may include a volatile memory (e.g., a flash memory) and a non-volatile memory (e.g., a non-volatile random-access memory (“NVRAM”)). In one embodiment, a computer program comprises a set of instructions that, when executed, perform one or more methods. The set of instructions may be stored on the mobile compatible memory 734, the expansion memory 758, a memory coupled to the mobile compatible processor 732, and a propagated signal that may be received, for example, over the transceiver 738 and/or the external interface 742.

The specific mobile computing device 730 may communicate wirelessly through the communication interface 752, which may be comprised of a digital signal processing circuitry. The communication interface 752 may provide for communications using various modes and/or protocols, such as, a Global System for Mobile Communications (“GSM”) protocol, a Short Message Service (“SMS”) protocol, an Enhanced Messaging System (“EMS”) protocol, a Multimedia Messaging Service (“MMS”) protocol, a Code Division Multiple Access (“CDMA”) protocol, Time Division Multiple Access (“TDMA”) protocol, a Personal Digital Cellular (“PDC”) protocol, a Wideband Code Division Multiple Access (“WCDMA”) protocol, a CDMA2000 protocol, and a General Packet Radio Service (“GPRS”) protocol.

Such communication may occur, for example, through the transceiver 738 (e.g., radio-frequency transceiver). In addition, short-range communication may occur, such as using a Bluetooth®, Wi-Fi, and/or other such transceiver. In addition, a GPS (“Global Positioning System”) receiver module 754 may provide additional navigation-related and location-related wireless data to the specific mobile computing device 730, which may be used as appropriate by a software application running on the specific mobile computing device 730.

The specific mobile computing device 730 may also communicate audibly using an audio codec 740, which may receive spoken information from a user and convert it to usable digital information. The audio codec 740 may likewise generate audible sound for a user, such as through a speaker (e.g., in a handset smartphone of the specific mobile computing device 730). Such a sound may comprise a sound from a voice telephone call, a recorded sound (e.g., a voice message, a music files, etc.) and may also include a sound generated by an application operating on the specific mobile computing device 730.

The specific mobile computing device 730 may be implemented in a number of different forms, as shown in the figure. In one embodiment, the specific mobile computing device 730 may be implemented as a smartphone 748. In another embodiment, the specific mobile computing device 730 may be implemented as a personal digital assistant (“PDA”). In yet another embodiment, the specific mobile computing device 730 may be implemented as a tablet device 750.

An example embodiment will now be described. Jane Smith may be actively dealing in the real estate market of Dallas, Tex. for the past couple of years. Jane Smith may have a client, John Doe, looking to buy an apartment in Phoenix, Ariz. Jane Smith may have approached a number of brokers/realtors active in the Phoenix, Ariz. market space, but she may have difficulty finding the best suited, qualified broker for her client, John Doe, who is willing to serve John Doe and offer the maximum brokerage for this referral.

Thanks to the invention described in the various embodiments of FIGS. 1-7, Jane Smith may now be able to identify a qualified broker willing to help John Doe in buying an apartment. The real estate broker referral network platform 110 of the real estate broker referral server 100 may enable Jane Smith to search for authentic brokers dealing in the Phoenix, Ariz. market space. Jane Smith may now be able to filter and sort the search results in the real estate broker referral network platform 110 for a well suited broker for her client, John Doe, who is also willing to pay the highest brokerage amount. Use of the various embodiments of FIGS. 1-7 may have enabled Jane Smith to negotiate the terms of agreement and the referral fee payable to her in exchange for the referral. In addition, use of various embodiments of FIGS. 1-7 may have allowed Jane Smith to keep track of and review the processes in order to monitor whether John Doe is being served well by the referred broker (e.g., recipient broker 132). Further, use of the various embodiments of FIGS. 1-7 may have ensured that Jane Smith is paid on time upon completion of the buying of the apartment by John Doe. Use of the various embodiments of FIGS. 1-7 may have made the whole process quite effortless and more efficient for Jane Smith saving her time and money.

A number of embodiments have been described. Nevertheless, it will be understood that various modifications may be made without departing from the spirit and scope of the claimed invention. In addition, the logic flows depicted in the figures do not require the particular order shown, or sequential order, to achieve the desired results. In addition, other steps may be provided, or steps may be eliminated, from the described flows, and other components may be added to, or removed from, the described systems. Accordingly, other embodiments are within the scope of the following claims.

It may be appreciated that the various systems, device and apparatus disclosed herein may be embodied in a machine-readable medium and/or a machine accessible medium compatible with a data processing system (e.g., a computer system), and/or may be performed in any order.

The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

What is claimed is:

1. A method, comprising:
providing an interface through which a referring broker to select a recipient broker chosen among a set of brokers in a second jurisdiction different than a first jurisdiction in which the referring broker is licensed;
automatically populating a set of information in a referral contract between the referring broker and the recipient broker comprising party names, a referred client name, a term limit, a commission percentage, a territory, an exclusivity parameter, and a set of governing terms based on a set of criteria provided by the referring broker and the recipient broker using a processor and a memory;
determining that the referred client has entered into an escrow associated with at least one of a sale of a real property, a purchase of the real property, and a lease of the real property with the recipient broker with an escrow provider;
automatically communicating the referral contract between the referring broker and the recipient broker to the escrow provider;
requesting that the escrow provider provide a consideration based on the commission percentage to the referring broker at a close of escrow associated with the at least one of the sale of the real property, the purchase of the real property, and the lease of the real property; and
crediting the consideration in a banking account of the referring broker upon the close of the escrow of associated with the at least one of the sale of the real property, the purchase of the real property, and the lease of the real property.

2. A method of contracting real estate broker referrals over a network comprising:
providing a real estate broker referral application to a user for installation on a user device,
wherein the user is a real estate broker;
receiving authentication of at least one of a license and a registration of the user at a server sent from a data source over the Internet, the transmission server comprising a processor and a memory;
receiving a request from a referring user to identify at least one authenticated recipient user at the server comprising the processor and the memory,
wherein the referring user is active in a first real estate market space,
wherein the at least one authenticated recipient user is active in a second real estate market space,
wherein a client of the referring user is needing to at least one of sell, buy and lease a property in the second real estate market space, and
wherein the processor to:
identify the at least one authenticated recipient user based on the request;
transmit the identification to the user device of the referring user,
wherein the identification activates the real estate broker referral application to cause the identification to display on the user device of the referring user;
generate a contract based on a selection of a specific authenticated recipient user by the referring user,
wherein the contract is between the specific authenticated recipient user and the referring user;
transmit the contract to the user device of the referring user and the user device of the specific authenticated recipient user,
wherein the contract activates the real estate broker referral application to cause the contract to display on the user device of the referring user and the user device of the specific authenticated recipient user,
wherein the contract is signed by the referring user and the authenticated recipient user;
storing the signed contract on the server.

3. The method of claim 2, wherein at least one of the license and the registration is required by a jurisdiction in which the user is active.

4. The method of claim 2, wherein the processor to further:
generate a list of all contracts in progress signed by the user; and
transmit the list of all contracts in progress to the user device,
wherein the list of all contracts activates the real estate broker referral application to cause the list of all contracts to display on the user device.

5. The method of claim 2, wherein the microprocessor to further automatically include in the contract at least one of a date and identifying information of at least one of the referring user, the specific authenticated recipient user, and the client.

6. The method of claim 5:
wherein each user offers a referral fee,
wherein the referral fee offered by a particular user at a first point in time is different from the referral fee offered by the particular user at a second point in time.

7. The method of claim 6, wherein the identification to include the authenticated recipient user offering a highest referral fee.

8. The method of claim 6, wherein the microprocessor to further automatically include in the contract the referral fee offered by the specific authenticated recipient user.

9. The method of claim 2, further comprising:
receiving a notice of escrow from the specific authenticated recipient user at the server,
wherein the notice of escrow to include at least one of an escrow number and an escrow officer contact information, and
wherein the processor to further:
automatically generate a demand to escrow to direct a transfer of a referral payment from the escrow to a trust account,
wherein the transferred referral payment to be associated with a unique identification, and
wherein the unique identification to also be associated with the contract; and
automatically transfer the referral payment to the referring user upon a notification of completion of the contract and a broker demand,
wherein the broker demand to include specify at least one of a method of transfer and a time of transfer.

10. The method of claim 9, wherein the processor to further:
aggregate all referral payments of the user received in a calendar year;
generate an at least one annual form required by at least one tax jurisdiction of the user based on the aggregation; and
transmit the at least one annual form to the user device of the user,
wherein the at least one annual form activates the real estate broker referral application to cause the at least one annual form to display on the user device of the user.
